(19) United States
(12) Patent Application Publication
(10) Pub. No.: US 2014/0198038 A1
(43) Pub. Date: Jul. 17, 2014

(54) DISPLAY DEVICE, CONTROL METHOD, AND PROGRAM

(71) Applicants: Ayumu Yagihashi, Kanagawa (JP); Seiji Sugahara, Tokyo (JP)

(72) Inventors: Ayumu Yagihashi, Kanagawa (JP); Seiji Sugahara, Tokyo (JP)

(73) Assignee: NEC CASIO MOBILE COMMUNICATIONS, LTD., Kanagawa (JP)

(21) Appl. No.: 14/240,344

(22) PCT Filed: Aug. 22, 2012
(86) PCT No.: PCT/JP2012/071193

§ 371 Date: Feb. 21, 2014

(30) Foreign Application Priority Data
Aug. 29, 2011 (JP) 2011-185660

(51) Int. Cl. G09G 5/00; G06F 3/14

(52) U.S. Cl. CPC G09G 5/003; G06F 3/1423
USPC 345/156

(57) ABSTRACT

A display device includes a plurality of displays provided on different surfaces of a body of the display device; a stationary state determination unit that determines whether or not the body is in a stationary state; a visibility determination unit that determines which of the displays is visible to a user if it is determined by the stationary state determination unit that the body is in a stationary state; and a display control unit that displays predetermined display information on at least the display that is determined by the visibility determination unit to be visible.

### TECHNICAL FIELD

The present invention relates to a display device, a control method, and a program. Priority is claimed on Japanese Patent Application No. 2011-185660, filed Aug. 29, 2011, the contents of which are incorporated herein by reference.

### BACKGROUND ART

Portable terminals such as a cellular phones and smartphones may have, in addition to a main display provided on the front side of its body, a sub-display provided on the back side of the body. Normally, the sub-display is smaller than the main display, and displays announcement information such as presence or absence of incoming call, received email, and the like.

Patent-Document 1 discloses a technique in which two displays having substantially the same display area are provided on the front and back sides of a portable terminal and are respectively utilized as a main display and a sub-display in accordance with results of measurement using an illuminance sensor or a posture sensor.

Accordingly, when a user picks up a portable terminal, the portable terminal operates in a manner such that a display that faces upward functions as the main display.

### PRIOR ART DOCUMENT

### Patent Document

### Patent Document 1: Japanese Unexamined Patent Application, First Publication No. 2009-71735.

### DISCLOSURE OF INVENTION

### Problem to be Solved by the Invention

However, when using a portable terminal as disclosed in Patent-Document 1, even when a display that faces downward faces a user (e.g., when the user is lying down while operating the portable terminal), a display that faces upward is set as the main display.

In light of the above problem, an object of the present invention is to provide a display device (a portable terminal), a control method, and a program, by which a display provided on a surface that faces the user can function as a main display.

### Means for Solving the Problem

In order to achieve the above object, the present invention provides a display device comprising:

a plurality of displays provided on different surfaces of a body of the display device;

a stationary state determination unit that determines whether or not the body is in a stationary state;

a visibility determination unit that determines which of the displays is visible to a user if it is determined by the stationary state determination unit that the body is in a stationary state; and

a display control unit that displays predetermined display information on at least the display that is determined by the visibility determination unit to be visible.

The present invention also provides a control method of a display device that has a plurality of displays provided on different surfaces of a body of the display device, wherein:

a stationary state determination unit determines whether or not the body is in a stationary state;

a visibility determination unit determines which of the displays is visible to a user if it is determined by the stationary state determination unit that the body is in a stationary state; and

a display control unit displays predetermined display information on at least the display that is determined by the visibility determination unit to be visible.

The present invention also provides a program that makes a display device, which has a plurality of displays provided on different surfaces of a body of the display device, function as:

a stationary state determination unit determines whether or not the body is in a stationary state;

a visibility determination unit determines which of the displays is visible to a user if it is determined by the stationary state determination unit that the body is in a stationary state; and

a display control unit displays predetermined display information on at least the display that is determined by the visibility determination unit to be visible.

### Effect of the Invention

In accordance with the present invention, while the display device is not operated and is laid on a desk or attached to a battery charge stand, predetermined display information as a main display is displayed on a display that is visible to a user. Therefore, a display provided on a surface that faces the user can function as the main display. Accordingly, after this setting, even if one of displays of the relevant portable terminal which faces downward becomes facing the user, the display determined (as the main display) when the portable terminal was in the stationary state can function as the main display.

### BRIEF DESCRIPTION OF THE DRAWINGS

FIG. 1 is a diagram showing appearance of a display device in accordance with a first embodiment of the present invention.

FIG. 2 is a general block diagram that shows the structure of the display device in the first embodiment of the present invention.

FIG. 3 is a flowchart showing the operation of the display device in accordance with the first embodiment.

FIG. 4 is a diagram showing appearance of a display device in accordance with a second embodiment of the present invention.

FIG. 5 is a general block diagram that shows the structure of the display device in the second embodiment of the present invention.

FIG. 6 is a flowchart showing the operation of the display device in accordance with the second embodiment.

### MODE FOR CARRYING OUT THE INVENTION

### First Embodiment

Below, embodiments of the present invention will be explained in detail with reference to the drawings.

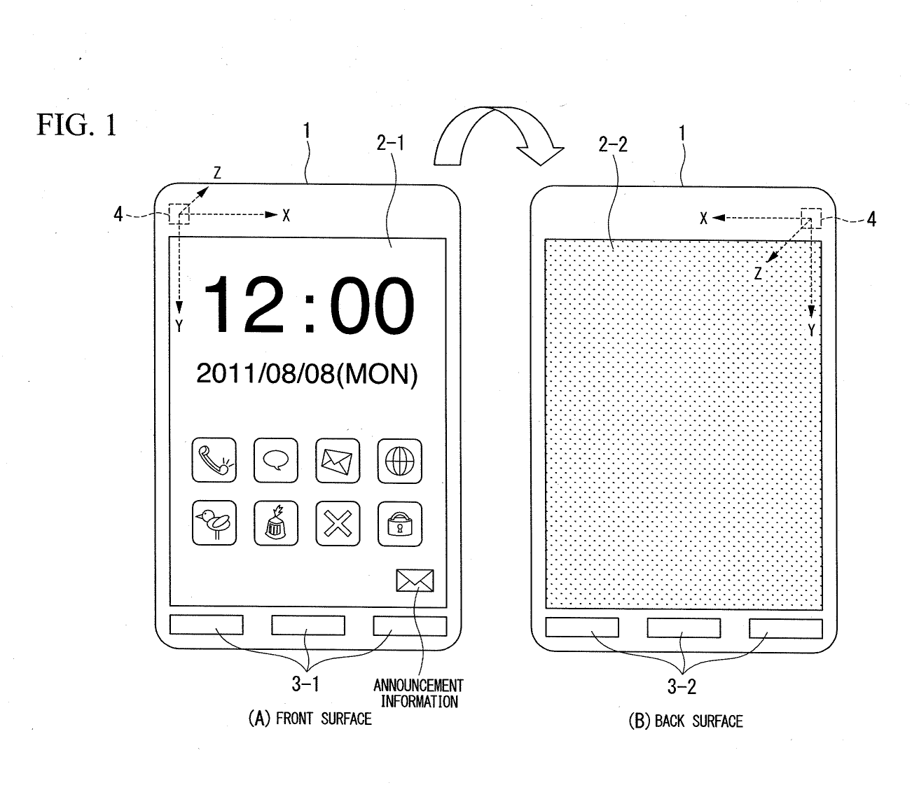

FIG. 1 is a diagram showing appearance of a display device in accordance with a first embodiment of the present invention.

The display device in accordance with the first embodiment of the present invention is a portable terminal such as a cellular phone or a smartphone.

The display device has a body 1 as a framework, a front (surface) display 2-1 provided on a surface (called a “front surface” below, see part (A) in FIG. 1), a back (surface) display 2-2 provided on a surface (called a “back surface” below, see part (B) in FIG. 1) opposite to the front surface, buttons 3-1 and buttons 3-2 which are respectively provided on the front and back surfaces of the body 1, an acceleration sensor 4, a computer system (not shown) formed by a CPU (Central Processing Unit), a memory, and the like, and a secondary cell (not shown) that supplies electric power to each structural element.

The front display 2-1 and the back display 2-2 have substantially the same display area. Additionally, a touch panel is superimposed on each of the front display 2-1 and the back display 2-2.

The buttons 3-1 and 3-2 are each provided at an end of the body 1 in the longitudinal direction thereof.

The acceleration sensor 4 measures an acceleration of the body 1 in each of X-axis, Y-axis, and Z-axis direction components. In the present embodiment, when the front surface of the body 1 is defined as a front surface and the end where the buttons 3-1 and 3-2 are provided is positioned downward, the positive direction along the X-axis is a direction defined from left to right in the width direction of the body 1. Similarly, when the front surface of the body 1 is defined as the front surface and the end where the buttons 3-1 and 3-2 are provided is positioned downward, the positive direction along the Y-axis is a direction defined from upward to downward in the longitudinal direction of the body 1. In addition, the positive direction along the Z-axis is a direction defined from the front surface to the back surface of the body 1.

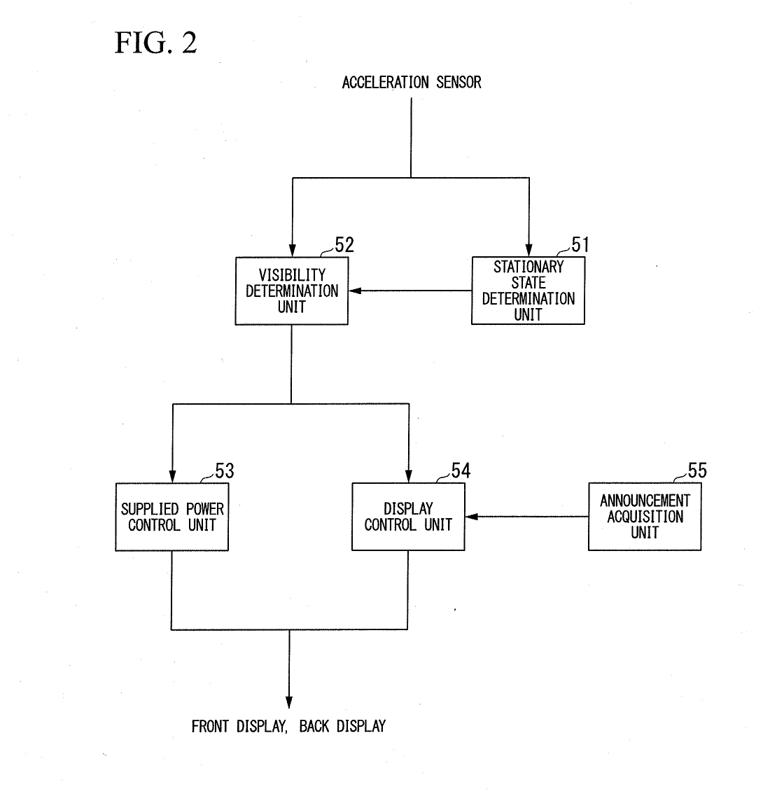

FIG. 2 is a general block diagram that shows the structure of the display device in the first embodiment of the present invention.

When the computer system provided in the display device executes a predetermined program, the display device possesses a stationary state determination unit 51, a visibility determination unit 52, a supplied power control unit 53, a display control unit 54, and an announcement acquisition unit 55.

The stationary state determination unit 51 determines, based on a signal output from the acceleration sensor 4, whether or not the body 1 is in a stationary state. More specifically, if there is no variation in the acceleration output from the acceleration sensor 4 during a predetermined time, the stationary state determination unit 51 determines that the body 1 is in a stationary state. This is because when a user holds the body 1, the user's motion is transmitted to the body 1, and a minute variation the acceleration is generated. In contrast, when the body 1 is laid on a desk or the like, the user's motion is transmitted to the body 1, and no acceleration other than gravitational acceleration is generated.

When it is determined that by the stationary state determination unit 51 that the body 1 is in a stationary state, the visibility determination unit 52 determines, based on a signal output from the acceleration sensor 4, whether the front display 2-1 or the back display 2-2 is visible to the user.

More specifically, if the acceleration in the Z-axis, which is measured by the acceleration sensor 4, is positive, the visibility determination unit 52 determines that the front display 2-1 is visible to the user while the back display 2-2 is not visible to the user.

In contrast, if the acceleration in the Z-axis, which is measured by the acceleration sensor 4, is negative, the visibility determination unit 52 determines that the back display 2-2 is visible to the user while the front display 2-1 is not visible to the user. This is because when the body 1 is in a stationary state, a display that faces downward probably faces a desk or the like.

The supplied power control unit 53 controls the supply of electric power, that is provided from the secondary cell, to the front display 2-1 and the back display 2-2.

The display control unit 54 displays a picture as a main display on the front display 2-1 or the back display 2-2. In addition, as shown in part (A) of FIG. 1, the display control unit 54 displays announcement information acquired by the announcement acquisition unit 55, on one of the front display 2-1 and the back display 2-2, which functions as the main display.

The announcement acquisition unit 55 acquires announcement information, that shows presence or absence of incoming call or received email, from an external device such as a server apparatus.

Below, operation of the display device in accordance with the first embodiment will explained.

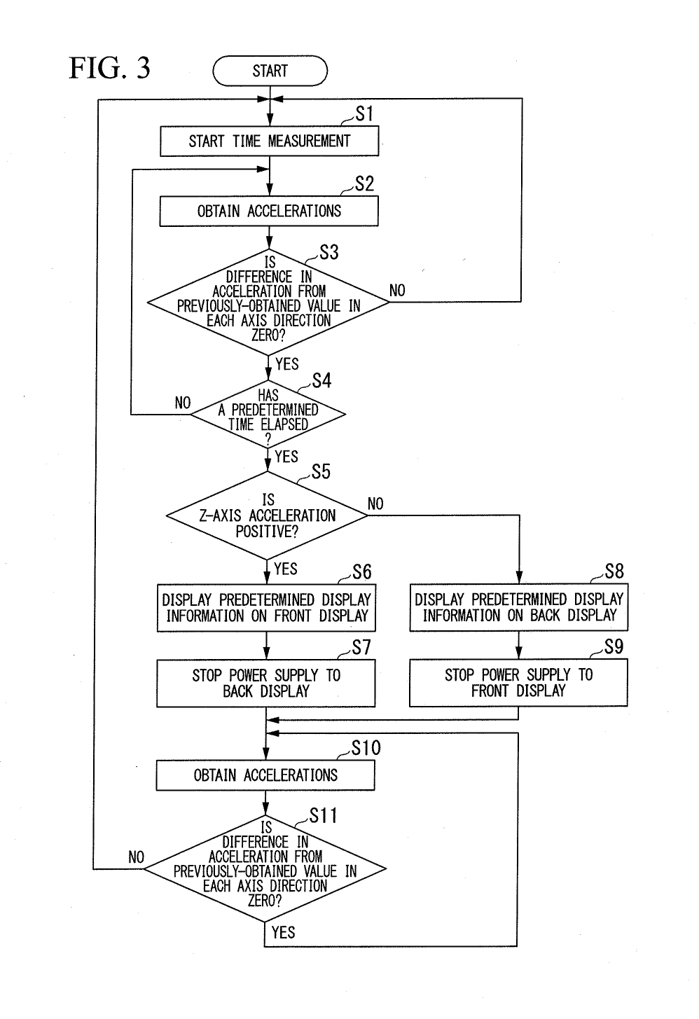

FIG. 3 is a flowchart showing the operation of the display device in accordance with the first embodiment.

First, when the display device has been activated, the stationary state determination unit 51 starts measurement of elapsed time from the current time (see step S1). Then the stationary state determination unit 51 and the visibility determination unit 52 obtain accelerations in the respective coordinate directions, which are measured by the acceleration sensor 4 (see step S2).

Next, the stationary state determination unit 51 computes a difference between the currently obtained accelerations in the coordinate directions with accelerations in the coordinate directions, which were obtained immediately before (and stored into an internal memory of the stationary state determination unit 51) so as to determine whether or not a difference in acceleration in each of the X-axis, Y-axis, and Z-axis directions is zero (see step S3).

If it is determined that the difference in acceleration in at least one of the X-axis, Y-axis, and Z-axis directions is not zero (i.e., “NO” in step S3), the operation returns to step S1, where the stationary state determination unit 51 starts the measurement of elapsed time from the current time again. In addition, the accelerations obtained in step S2 are stored into the internal memory.

On the other hand, if it is determined that the difference in acceleration in every one of the X-axis, Y-axis, and Z-axis directions is zero (i.e., “YES” in step S3), the stationary state determination unit 51 determines whether or not the elapsed time whose measurement was started in step S1 has reached a predetermined value (see step S4).

If it is determined that the elapsed time has not reached the predetermined value (i.e., “NO” in step S4), the operation returns to step S2, where the stationary state determination unit 51 obtains subsequent accelerations. In addition, the accelerations obtained in step S2 are stored into the internal memory.

On the other hand, if it is determined by the stationary state determination unit 51 that the elapsed time has reached the predetermined value (i.e., “YES” in step S4), the visibility determination unit 52 determines whether or not the Z-axis acceleration obtained in step S2 indicates a positive value (see step S5).

If it is determined that the Z-axis acceleration indicates a positive value (i.e., “YES” in step S5), the visibility determination unit 52 determines that the front display 2-1 is in a visible state.

In this case, the display control unit 54 displays predetermined display information as a main display on the front display 2-1 (see step S6), and the supplied power control unit 53 stops the power supply to the back display 2-2 (see step S7).

In contrast, if it is determined that the Z-axis acceleration indicates a negative value (i.e., “NO” in step S5), the visibility determination unit 52 determines that the back display 2-2 is in a visible state.

In this case, the display control unit 54 displays predetermined display information as a main display as a main display on the back display 2-2 (see step S8), and the supplied power control unit 53 stops the power supply to the front display 2-1 (see step S9).

Accordingly, the main display can be set to one of the displays which is visible to the user. In addition, power consumption of the secondary cell can be reduced by stopping the power supply to the other display.

After stopping the power supply to the front display 2-1 or the back display 2-2 in step S7 or S9, the stationary state determination unit 51 obtains accelerations in each of the coordinate directions, which are measured by the acceleration sensor 4 (see step S10).

Next, the stationary state determination unit 51 computes a difference between the currently obtained accelerations in the coordinate directions with accelerations in the coordinate directions, which were obtained immediately before, so as to determine whether or not a difference in acceleration in each of the X-axis, Y-axis, and Z-axis directions is zero (see step S11).

If it is determined that the difference in acceleration in every one of the X-axis, Y-axis, and Z-axis directions is zero (i.e., “YES” in step S11), the stationary state determination unit 51 determines that the stationary state of the body 1 has been maintained, and the operation returns to step S10, where the stationary state determination unit 51 obtains subsequent accelerations.

On the other hand, if it is determined that the difference in acceleration in at least one of the X-axis, Y-axis, and Z-axis directions is not zero (i.e., “NO” in step S11), the stationary state determination unit 51 determines that the body 1 has been moved, and the operation returns to step S1, where the stationary state determination unit 51 starts the measurement of elapsed time from the current time again.

As described above, according to the first embodiment, when the body 1 is set to be in a stationary state, a display set as the main display is determined. After the body 1 is picked up by the user, a control is performed in which the above display determined when the body 1 was in the stationary state functions as the main display until the body 1 is set to be a stationary state again.

If the user is lying down while operating a portable terminal as disclosed in the above-described Patent-Document 1, a problem occurs in which the main display for the portable terminal is switched from one to another. Originally, while the user holds the portable terminal, it is evident that the user, who has turned the portable terminal over, wants to look at the sub-display. Therefore, it is preferable that the switching of the main display from one to another does not happen. On the other hand, when the portable terminal is laid somewhere, it is preferable that the main display be set to one of the displays which faces upward, regardless of which display faces upward by the user's action.

Therefore, while the user holds the portable terminal, the portable terminal of the first embodiment does not perform a switching control of the main display. That is, the portable terminal determines the main display every time the portable terminal becomes in a stationary state. Accordingly, after the user picks up the portable terminal which has been in a stationary state, a display, which was determined as the main display when the portable terminal was in the stationary state, can function as the main display even if a display that faces downward also faces the user who is lying down while operating the portable terminal.

That is, while the user holds the portable terminal, the portable terminal does not perform the switching for the main display even if the portable terminal is turned over. Additionally, when the portable terminal is set to be a stationary state, the main display can be set to a display which faces upward regardless of which surface of the portable terminal the user sets upward.

### Second Embodiment

Below, a second embodiment of the present invention will be explained.

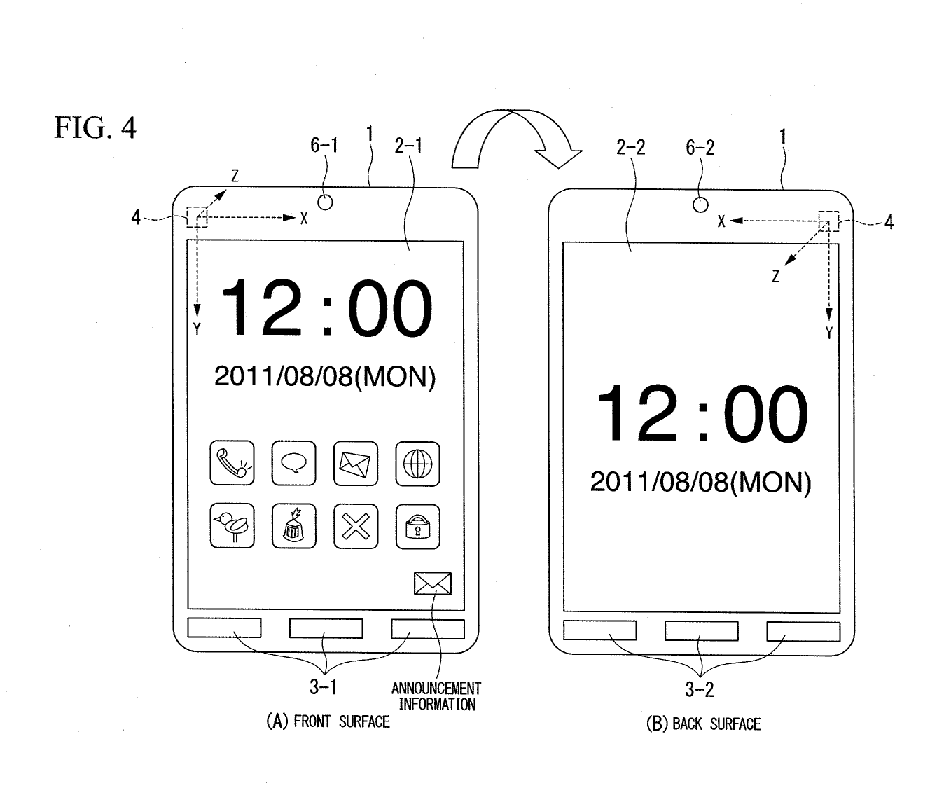

FIG. 4 is a diagram showing appearance of a display device in accordance with the second embodiment of the present invention.

In addition to the displays in accordance with the first embodiment, the second embodiment has illuminance sensors 6-1 and 6-2 that are respectively arranged on the front and back surfaces of the body 1.

The illuminance sensors 6-1 and 6-2 each measure an intensity (illuminance) of light emit into the respective front and back surfaces of the body 1.

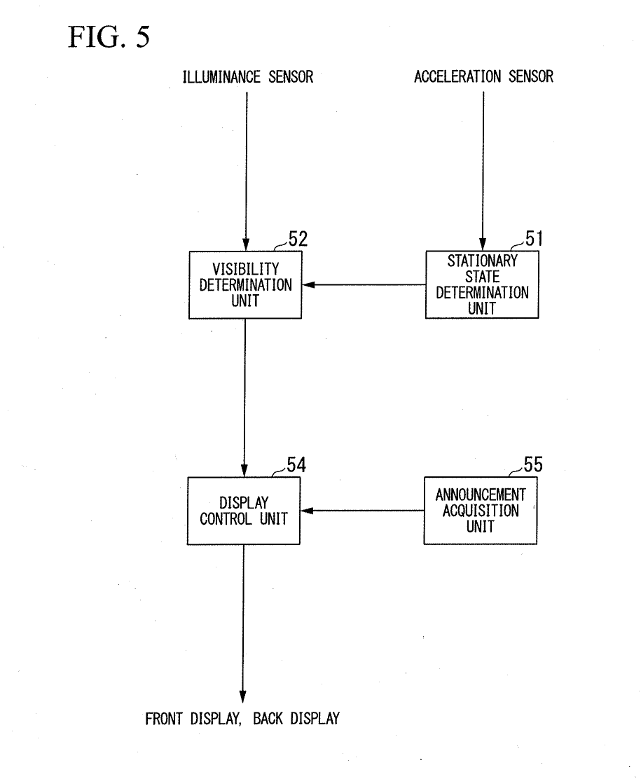

FIG. 5 is a general block diagram that shows the structure of the display device in the second embodiment of the present invention.

When the computer system provided in the display device executes a predetermined program, the display device possesses a stationary state determination unit 51, a visibility determination unit 52, a display control unit 54, and an announcement acquisition unit 55.

In the second embodiment, the visibility determination unit 52 and the display control unit 54 operate in a manner different from that in the first embodiment.

When it is determined by the stationary state determination unit 51 that the body 1 is in a stationary state, the visibility determination unit 52 determines, based on signals output from the illuminance sensors 6-1 and 6-2, which of the front display 2-1 and the back display 2-2 is visible to the user.

More specifically, when the illuminance measured by the illuminance sensor 6-1 is greater than the illuminance measured by the illuminance sensor 6-2, the visibility determination unit 52 determines that the front display 2-1 is visible to the user while the back display 2-2 is not visible to the user. On the other hand, when the illuminance measured by the illuminance sensor 6-1 is greater than the illuminance measured by the illuminance sensor 6-2, the visibility determination unit 52 determines that the back display 2-2 is visible to the user while the front display 2-1 is not visible to the user.

This is because when the body 1 is in a stationary state, a display that faces downward probably faces a desk or the like, and thus has a lower illuminance.

According to such comparison between signals output from both illuminance sensors, it is possible to determine which surface has an illuminance (measured by the illuminance sensor) greater than or equal to a predetermined threshold.

The display control unit 54 displays a picture as a main display on the front display 2-1 or the back display 2-2.

In addition, as shown in part (A) of FIG. 4, the display control unit 54 displays announcement information acquired by the announcement acquisition unit 55, on one of the front display 2-1 and the back display 2-2, which functions as the main display.

Below, operation of the display device in accordance with the second embodiment will explained.

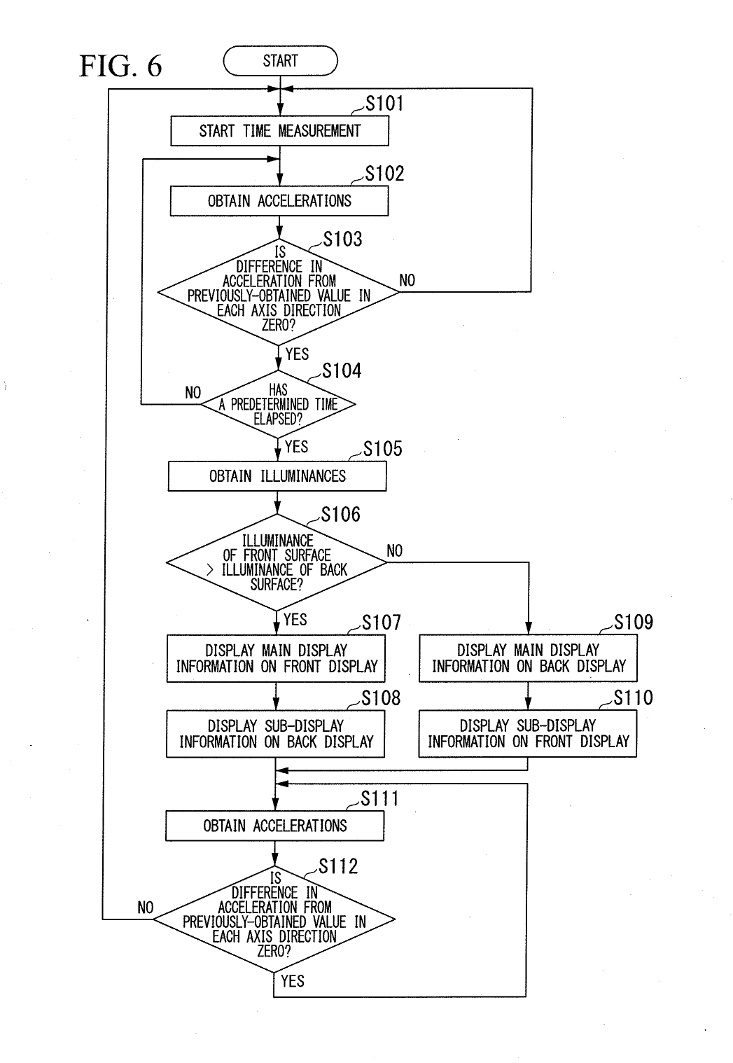

FIG. 6 is a flowchart showing the operation of the display device in accordance with the second embodiment.

First, when the display device has been activated, the stationary state determination unit 51 starts measurement of elapsed time from the current time (see step S101). The stationary state determination unit 51 and the visibility determination unit 52 obtain accelerations in each coordinate direction, which are measured by the acceleration sensor 4 (see step S102).

Next, the stationary state determination unit 51 computes a difference between the currently obtained accelerations in the coordinate directions with accelerations in the coordinate directions, which were obtained immediately before, so as to determine whether or not a difference in acceleration in each of the X-axis, Y-axis, and Z-axis directions is zero (see step S103).

If it is determined that the difference in acceleration in at least one of the X-axis, Y-axis, and Z-axis directions is not zero (i.e., “NO” in step S103), the operation returns to step S101, where the stationary state determination unit 51 starts the measurement of elapsed time from the current time again. In addition, the accelerations obtained in step S102 are stored into the internal memory.

On the other hand, if it is determined that the difference in acceleration in every one of the X-axis, Y-axis, and Z-axis directions is zero (i.e., “YES” in step S103), the stationary state determination unit 51 determines whether or not the elapsed time whose measurement was started in step Si has reached a predetermined value (see step S104).

If it is determined that the elapsed time has not reached the predetermined value (i.e., “NO” in step S104), the operation returns to step S102, where the stationary state determination unit 51 obtains subsequent accelerations. In addition, the accelerations obtained in step S102 are stored into the internal memory.

On the other hand, if it is determined by the stationary state determination unit 51 that the elapsed time has reached the predetermined value (i.e., “YES” in step S104), the visibility determination unit 52 obtains illuminances of the front and back surfaces of the body 1 from the respective illuminance sensors 6-1 and 6-2 (see step S 105). Then the visibility determination unit 52 determines whether or not the illuminance of the front surface is greater than the illuminance of the back surface (see step S106).

If it is determined that the illuminance of the front surface is greater than the illuminance of the back surface (i.e., “YES” in step S106), the visibility determination unit 52 determines that the front display 2-1 is in a visible state.

In this case, the display control unit 54 displays predetermined display information as a main display on the front display 2-1 (see step S107), and also displays predetermined display information as a sub-display on the back display 2-2 (see step S108).

On the other hand, if it is determined that the illuminance of the back surface is greater than or equal to the illuminance of the back surface (i.e., “NO” in step S106), the visibility determination unit 52 determines that the back display 2-2 is in a visible state.

In this case, the display control unit 54 displays predetermined display information as a main display on the back display 2-2 (see step S109), and also displays predetermined display information as a sub-display on the front display 2-1 (see step S110).

Accordingly, the main display can be set to one of the displays which is visible to the user.

After displaying the display information as the sub-display on the front display 2-1 to the back display 2-2 or the front display 2-1 in step S108 or S110, the stationary state determination unit 51 obtain accelerations in the respective coordinate directions, which are measured by the acceleration sensor 4 (see step S111).

Next, the stationary state determination unit 51 computes a difference between the currently obtained accelerations in the coordinate directions with accelerations in the coordinate directions, which were obtained immediately before, so as to determine whether or not a difference in acceleration in each of the X-axis, Y-axis, and Z-axis directions is zero (see step S112).

If it is determined that the difference in acceleration in every one of the X-axis, Y-axis, and Z-axis directions is zero (i.e., “YES” in step S112), the stationary state determination unit 51 determines that the stationary state of the body 1 has been maintained, and the operation returns to step S111, where the stationary state determination unit 51 obtains subsequent accelerations.

On the other hand, if it is determined that the difference in acceleration in at least one of the X-axis, Y-axis, and Z-axis directions is not zero (i.e., “NO” in step S112), the stationary state determination unit 51 determines that the body 1 has been moved, and the operation returns to step S101, where the stationary state determination unit 51 starts the measurement of elapsed time from the current time again.

As described above, according to the second embodiment and similar to the first embodiment, when the body 1 is set to be in a stationary state, a display set as the main display is determined. After the body 1 is picked up by the user, a control is performed in which the above display determined when the body 1 was in the stationary state functions as the main display until the body 1 is set to be a stationary state again.

Accordingly, after the user picks up the portable terminal which has been in a stationary state, a display, which was determined as the main display when the portable terminal was in the stationary state, can function as the main display even if a display that faces downward also faces the user who is lying down while operating the portable terminal.

While embodiments of the present invention have been explained in detail referring to the drawings, specific structures are not limited to those described above. Various design modifications can be made without departing from the scope of the present invention.

For example, in the first embodiment, the visible display is determined utilizing the acceleration sensor 4, and power supply to the non-visible display is stopped. In the second embodiment, the visible display is determined utilizing the illuminance sensors 6-1 and 6-2, and display information as a sub-display is displayed on the non-visible display.

However, embodiments are not limited to those described above. For example, the visible display may be determined utilizing the acceleration sensor 4 while display information as a sub-display is displayed on the non-visible display. In another example, the visible display may be determined utilizing the illuminance sensors 6-1 and 6-2 while power supply to the non-visible display may be stopped.

Additionally, in the present embodiments, while the portable terminal is not in a stationary state, no determination for a visible display is performed. However, this is not a limited condition. For example, determination for a visible display may be performed utilizing a certain device so as to appropriately switch the main display.

In addition, in the present embodiments, two displays are provided on the front and back surfaces of the relevant body. However, this is not a limited condition, and three or more displays may be provided.

The above-described display device includes a computer system. The above-described operation of each unit is stored as a program in a computer-readable storage medium, and the operation is performed when the relevant computer loads and executes the program.

The above computer readable storage medium is a magnetic disk, magneto optical disk, CD-ROM, DVD-ROM, semiconductor memory, or the like.

In addition, the relevant computer program may be provided to a computer via a communication line, and the computer which received the program may execute the program.

In addition, the program may execute a part of the above-explained functions.

The program may also be a program (a so-called “differential file (differential program)”) by which the above-described functions can be executed by a combination of this program and an existing program which has already been stored in the relevant computer system.

### INDUSTRIAL APPLICABILITY

In accordance with the present invention, while the display device is not operated and is laid on a desk or attached to a battery charge stand, predetermined display information as a main display is displayed on a display that is visible to a user. Therefore, a display provided on a surface that faces the user can function as the main display. Accordingly, after this setting, even if one of displays of the relevant portable terminal which faces downward becomes facing the user, the display determined (as the main display) when the portable terminal was in the stationary state can function as the main display.

### Reference Symbols

1 body
2-1 front display
2-2 back display
3-1, 3-2 buttons
4 acceleration sensor
51 stationary state determination unit
52 visibility determination unit
53 supplied power control unit
54 display control unit
55 announcement acquisition unit
6-1, 6-2 illuminance sensor

1. A display device comprising:
a plurality of displays provided on different surfaces of a body of the display device;
a stationary state determination unit that determines whether or not the body is in a stationary state;
a visibility determination unit that determines which of the displays is visible to a user if it is determined by the stationary state determination unit that the body is in a stationary state; and
a display control unit that displays predetermined display information on at least the display that is determined by the visibility determination unit to be visible.

2. The display device in accordance with claim 1, further comprising:
an announcement acquisition unit that acquires announcement information from an external device,
wherein the display control unit displays the announcement information acquired by the announcement acquisition unit on the display that is determined by the visibility determination unit to be visible.

3. The display device in accordance with claim 1, further comprising:
a supplied power control unit that reduces electric power supplied to the display that is determined by the visibility determination unit to be non-visible.

4. The display device in accordance with claim 1, further comprising:
an acceleration sensor that measures an acceleration applied to the body,
wherein the stationary state determination unit determines that the body is in a stationary state if a state in which there is no variation in the acceleration measured by the acceleration sensor has continued for a predetermined time.

5. The display device in accordance with claim 4, wherein:
the visibility determination unit determines one of the surfaces of the body, which faces a direction toward which the acceleration is detected by the acceleration sensor, is not visible to the user.

6. The display device in accordance with claim 4, further comprising:
illuminance sensors that are arranged on the respective surfaces on which the displays are provided, where the illuminance sensors each measure an intensity of light emit into the relevant surface on which the corresponding illuminance sensor is arranged,
wherein it is determined that one of the surfaces of the body, which has an illuminance greater than or equal to a predetermined threshold, is determined to be visible to the user, where the illuminance is measured by the corresponding illuminance sensor.

7. A control method of a display device that has a plurality of displays provided on different surfaces of a body of the display device, wherein:
a stationary state determination unit determines whether or not the body is in a stationary state;
a visibility determination unit determines which of the displays is visible to a user if it is determined by the stationary state determination unit that the body is in a stationary state; and
a display control unit displays predetermined display information on at least the display that is determined by the visibility determination unit to be visible.

8. A non-transitory computer-readable storage medium which stores a program that makes a display device, which has a plurality of displays provided on different surfaces of a body of the display device, function as:
a stationary state determination unit determines whether or not the body is in a stationary state;
a visibility determination unit determines which of the displays is visible to a user if it is determined by the stationary state determination unit that the body is in a stationary state; and
a display control unit displays predetermined display information on at least the display that is determined by the visibility determination unit to be visible.
